(19) United States
(12) Patent Application Publication
(10) Pub. No.: US 2001/0053682 A1
(43) Pub. Date: Dec. 20, 2001

(54) Mobile device for power supply and data storage

(75) Inventor: Steven Cheng, Chung-Ho City (TW)

Correspondence Address: ROTHWELL, FIGG, ERNST & MANBECK, P.C., 555 13TH STREET, N.W., SUITE 701, EAST TOWER, WASHINGTON, DC, 20004, US

(73) Assignee: DYNA DATA SYSTEM CORPORATION

(21) Appl. No.: 09/879,965

(22) Filed: Jun. 14, 2001

(30) Foreign Application Priority Data
Jun. 17, 2000 (TW) 89210379

(51) Int. Cl. H04B 1/16

(52) U.S. Cl. 455/343; 455/572

(57) ABSTRACT

A mobile device for power supply and data storage is proposed, which includes a power supply module, an input/output interface module, a controlling module and a memory module. When the foregoing mobile device is externally connected with a small mobile electric device, power outputted from an output circuit of the power supply module to the electric device can be adjusted by the controlling module, so as to provide a suitable amount of power for the electric device. Moreover, when data storage of the electric device is insufficient for storing further data, the controlling module allows a write in/read out unit of the input/output interface module to write in the data, and then transmits the data to the memory module to be stored therein. Therefore, the mobile device for power supply and data storage of the invention can be widely applied to various mobile electric devices by the adjustable output power thereof, and can provide additional data storage in the condition of insufficiency in data storage occurring in the electric devices.

### FIELD OF THE INVENTION

The present invention relates to mobile devices for power supply and data storage, and more particularly, to a mobile device which provides power and data storage for small mobile electric devices.

### BACKGROUND OF THE INVENTION

A battery is normally required as a power source for a small mobile electric device such as a translator and a mobile scanner in the condition that electricity from an electricity company is not available.

Generally, the small mobile electric device has an applicable voltage thereof within the range of 3 V to 9 V, and batteries used for the small mobile electric devices vary in dimension and voltage specification. As a result, a user normally needs to purchase various batteries for operating the electric devices. In such a condition of no uniform specification for the batteries, the compatibility between different electric devices is reduced, and inconvenience in operation and in purchase is generated. Moreover, in application of the small mobile electric device with data storage being mounted therein, problems in processing data are produced if the data are inputted over the capacity of the data storage.

Therefore, when using the small mobile electric device provided with the data storage, if a user is in a location or situation where electricity from the electricity company is unavailable, and the data storage of the electric device is insufficient for storing further data therein, problems in operating the electric device are generated. As such, a mobile device for power supply and data storage is essentially required, so as to provide electricity and additional data storage for the small mobile electric device.

In order to solve the foregoing drawbacks of variety in battery specifications, variety in applicable voltages for small mobile electric devices and insufficiency in data storage of the small mobile electric devices, a mobile device for power supply and data storage is proposed in the present invention. The mobile device for power supply and data storage of the invention adjusts its power outputted to the small mobile electric device according to the applicable voltage of the electric device, so that the mobile device of the invention can be applied to various small mobile electric devices having different applicable voltages thereof, allowing the small mobile electric devices to be more compatible to each other in operation and more convenient in moving and carriage thereof. In addition, the mobile device of the invention also provides additional data storage for the small mobile electric devices with data storage being installed therein.

### SUMMARY OF THE INVENTION

It is therefore an objective of the present invention to provide a mobile device for power supply and data storage which adjusts the output power thereof to an electric device according to an applicable voltage of the electric device.

It is another objective of the invention to provide a mobile device for power supply and data storage which provides additional data storage for an electric device with data storage being installed therein.

It is still another objective of the invention to provide a mobile device for power supply and data storage which eliminates the requirement of specific batteries used for various electric devices.

In accordance with the foregoing and other objectives of the invention, a mobile device for power supply and data storage is proposed, which is provided with a plurality of batteries and a plurality of memory devices, so as to provide power and additional data storage for small mobile electric devices having data storage installed therein. The mobile device of the invention comprises a power supply module including a power source, an output circuit and an internal circuit, an input/output interface module including a read in/read out unit and an internal signal setting unit, a controlling module, and a memory module. The mobile device of the invention containing the plurality of batteries adjusts its output power according to an applicable voltage of an electric device by means of the controlling module, so as to provide a suitable amount of power for the small mobile electric devices. In addition, the mobile device of the invention containing the plurality of memory devices provides additional data storage for the small mobile electric devices having data storage installed therein.

First, the plurality of batteries are places in the power source of the power supply module. Then, the output circuit outputs power to the small mobile electric device externally connected thereto, whereas the internal circuit provides part of power for using in the modules of the mobile device for power supply and data storage of the invention. When providing power for the small mobile electric device, if the mobile device of the invention has its output power larger than the applicable voltage of the electric device, it can adjust the output power thereof by means of the controlling module so as to provide a suitable amount of power to the electric device. When providing power for the electric device having data storage mounted therein, if the data storage of the electric device is running out of space for storing further inputted data therein, the controlling module allows the write in/read out unit to read in the data, and then transmits the write-in data to the memory module for storage. As such, the mobile device of the invention achieves the storage for huge amount of data for the electric device. For reading out the data stored in the memory module, the controlling module allows the read-out process to be performed, so that the data stored in the memory module can be read out by the write in/read out unit.

### BRIEF DESCRIPTION OF THE DRAWINGS

The invention can be more fully understood by reading the following detailed description of the preferred embodiments, with reference made to the accompanying drawings, wherein:

FIG. 1 is a block diagram showing the basic structure of the mobile device for power supply and data storage of the invention; and

FIG. 2 is a block diagram showing the connection between the mobile device for power supply and data storage of the invention and a mobile scanning device.

### DETAILED DESCRIPTION OF THE PREFERRED EMBODIMENT

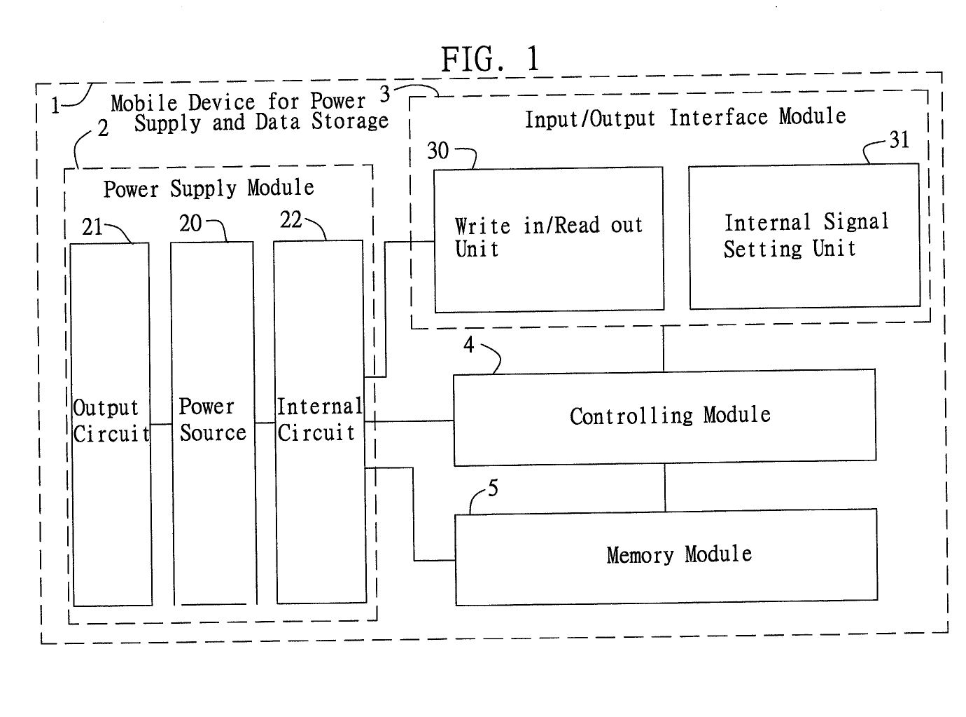

FIG. 1 is a block diagram illustrating the basic structure of the mobile device for power supply and data storage of the invention. As shown in the drawing, the mobile device for power supply and data storage 1 of the invention comprises a power supply module 2, an input/output interface module 3, a controlling module 4 and a memory module 5.

The power supply module 2 includes a power source 20, an output circuit 21 and an internal circuit 22. A plurality of batteries are placed in an installing space (not shown) of the power source 20, allowing the power supply module 2 to be able to provide power. The output circuit 21 is used to provide power for a mobile electric device externally connected thereto, and the internal circuit 22 provides power for the modules of the mobile device for power supply and data storage 1 of the invention, so as to make the electric device and the mobile device 1 of the invention both work properly. Further, the output circuit 21 has electric wire (not shown) for outputting power thereof being in the form of a coil received in a receiving space inside the mobile device 1 of the invention, wherein the electric wire can be uncoiled to extend over a long distance for externally connecting with an electric device, and has one end thereof being provided with an output terminal (not shown) to be received in the externally connected electric device. Moreover, after power supply is completed with the output terminal disconnected from the electric device, the output circuit 21 provided with a coil button (not shown) allows the electric wire to be coiled back to the receiving space by pushing the coil button, so as to make the mobile device 1 of the invention more convenient in carriage.

The input/output interface module 3 includes a write in/read out unit 30 and an internal signal setting unit 31. The write in/read out unit 30 acts as a data transmitting channel between the externally connected electric device and the mobile device 1 of the invention, and can be mounted with a connecting terminal (not shown) as a data transmitting port to be connected with input/output interface of the electric device, allowing the write in/read out process to be performed for data to stored. The internal signal setting unit 31 allows a user to input a controlling signal thereto, wherein the controlling signal comprises a signal for writing in the data to be stored or reading out the stored data, and a signal for controlling the power supply. Therefore, an input device such as a switch or a keyboard is required for the controlling signal to be inputted thereby, and then the controlling signal is transmitted to the controlling module 4.

The controlling module 4 is a central processing unit of the invention, which is used to adjust the power supplied by the power supply module 2 of the invention to the externally connected electric device, and controls the write-in process for the data to be stored and the read-out process for the stored data between the mobile device 1 of the invention and the externally connected electric device.

The memory module 5 consists of DRAM, SRAM or flash memory. When the data storage of the externally connected electric device is insufficient for storing further data therein, the memory module 5 provides additional data storage for the electric device. Further, the memory module 5 is designed with a receiving space (not shown), allowing to removably install the data storage therein, wherein, when data are inputted over the capacity of the data storage, the data storage can be replaced by another storage having greater capacity thereof, e.g. flash memory with a card structure, so as to complete the process of data storage. The card structure comprises the flash memory card and smart medium card, wherein the flash memory card uses surface mounting technology to densely encapsulate the flash memory on a printed substrate, and the smart medium card is substantially thinner than the flash memory card in thickness. Since art related to the flash memory card structure is conventional, thus not to be described herewith.

First, a plurality of batteries are placed in the installing space of the power source 20 of the power supply module 2. Then, the output circuit 21 outputs power to a small mobile electric device externally connected thereto, whereas the internal circuit 22 provides part of power for using in the modules of the mobile device for power supply and data storage 1 of the invention. When providing power for the externally connected electric device, if the mobile device 1 of the invention has an output voltage larger than an applicable voltage of the electric device, the controlling module 4 then adjusts the output power of the power supply module 2. For example, if the batteries installed in the mobile device 1 of the invention are totally 9 V in voltage, and the applicable voltage of the externally connected electric device is 3 V, the internal signal setting unit 31 of the input/output interface module 3 can be set with the value of output power to be 3 V, allowing the controlling module 4 to adjust the power outputted to the externally connected electric device to be 3 V. Therefore, the mobile device 1 of the invention, which adjusts the power supplied to the externally connected electric device if necessary, can be widely used for various small mobile electric devices. When the data storage of the externally connected electric device is insufficient for storing further data therein, the internal signal setting unit 31 of the input/output interface module 3 can be inputted with a controlling signal, i.e. a signal for writing in data to be stored, so that the controlling module 4 activates the write in/read out unit 30 of the input/output interface module 3 to write in the data transmitted through a data port of the externally connected electric device, and then transmits the write-in data to the memory module 5 for storage. For reading out the data stored in the memory module 5, a controlling signal i.e. a signal for reading out the stored data can be inputted to the internal signal setting unit 31 of the input/output interface module 3, and then the controlling module 4 allows the write in/read out unit 30 of the input/output interface module 3 to read out the stored data.

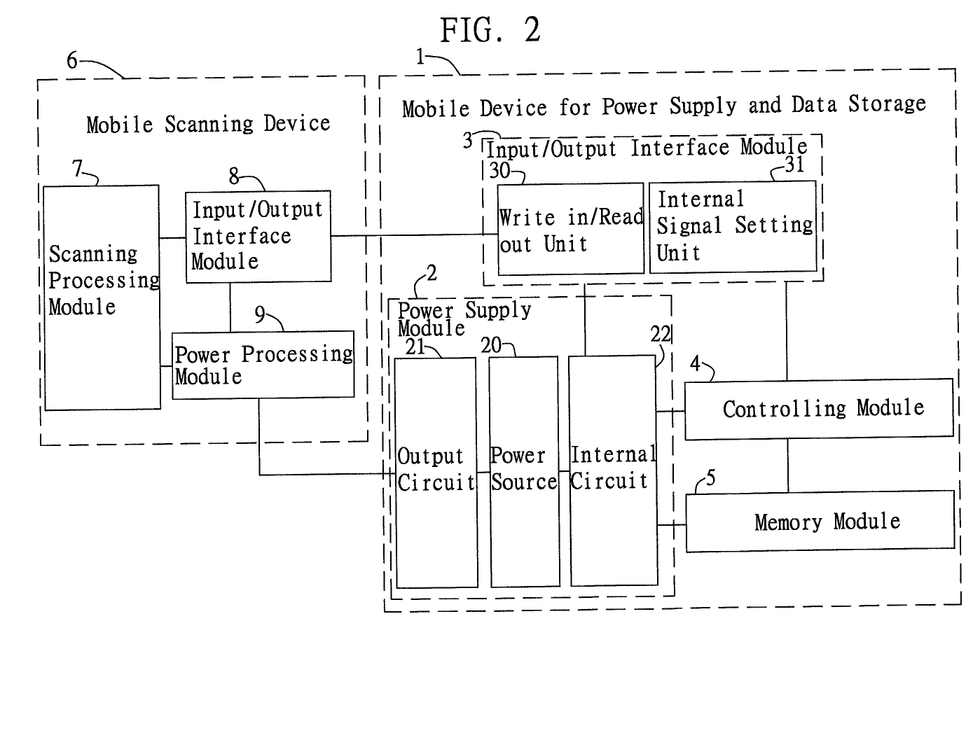

FIG. 2 is a block diagram illustrating the connection between the mobile device for power supply and data storage of the invention and a mobile scanning device. Since the mobile scanning device 6 is not an essential element of the invention, so that only part of internal structure of the scanning device 6 related to the invention is described herewith. As shown in the drawing, when the mobile device for power supply and data storage 1 of the invention is connected with the mobile scanning device 6, first, a plurality of batteries are placed in an installing space (not shown) of the power source 20. Then, the output circuit 21 outputs power to a power processing module 9 of the mobile scanning device 6 so as to activate the scanning device 6. Further, the internal circuit 22 provides part of power for using in the modules of the mobile device 1 of the invention. If the mobile device 1 of the invention has an output voltage larger than an applicable voltage of the scanning device 6, the controlling module 4 then allows the adjustment of the output voltage of the power supply module 2 according to the applicable voltage of the scanning device 6 by means of the internal signal setting unit 31 of the input/output interface module 3 being inputted with a desired voltage value. If data storage of the mobile scanning device 6 is insufficient for storing further data scanned by a scanning processing module 7 therein, first, data bus (not shown) is used to connect a data connecting port (not shown) of an input/output interface module 8 of the scanning device 6 and a data connecting port (not shown) of the write in/read out unit 30 of the input/output interface module 3. Then, a controlling signal, i.e. a signal for writing in the data to be stored, is inputted to the internal signal setting unit 31 of the input/output interface module 3, so that the controlling module 4 activates the write in/read out unit 30 of the input/output interface module 3 to read in the data transmitted through the data connecting port of the scanning device 6, so as to store the write-in data in the memory module 5. If the data are inputted over the capacity of the data storage in the memory module 5, the data storage can be removed from a receiving space (not shown) of the memory module 5 and replaced by another storage with greater capacity thereof, so as to complete the process for data storage. For reading out the data stored in the memory module 5, a controlling signal, i.e. a signal for reading out the stored data, is inputted to the internal signal setting unit 31 of the input/output interface module 3, so that the controlling module 4 activates the write in/read out unit 30 of the input/output interface module 3 to read out the data stored in the memory module 5.

In conclusion, the mobile device for power supply and data storage of the invention adjusts its output power according to the applicable voltage of an electric device externally connected therewith, and provides additional data storage for the electric device if data storage of the electric device is insufficient for storing further data therein. Therefore, the mobile device of the invention can be widely used in various small mobile electric devices due to the adjustable output power thereof, and can provide additional data storage to eliminate the insufficiency in data storage for the electric devices.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A mobile device for power supply and data storage, which comprises:
a power supply module including a power source, an output circuit outputting power from the power source to an electric device externally connected with the mobile device, and an internal circuit providing power from the power source for the mobile device;
an input/output interface module electrically coupled to the internal circuit, including a write in/read out unit and an internal signal setting unit, the write in/read out unit acting as a transmitting channel connecting data stored in the mobile device and in the electric device, the internal signal setting unit allowing a controlling signal to be inputted thereto;
a controlling module electrically coupled to the internal circuit for adjusting the power outputted from the output circuit, and for controlling the write-in process for data to be stored and the read-out process for the stored data between the mobile device and the electric device; and
a memory module electrically coupled to the internal circuit and storing the data transmitted from the electric device.

2. The mobile device of claim 1, wherein the output circuit has electric wire received in a receiving space of the mobile device in the form of a coil, which can be uncoiled to extend outside the mobile device for providing power over long distance.

3. The mobile device of claim 2, wherein the output circuit has one end of the electric wire thereof being mounted with an output terminal, which outputs power to the electric device connected therewith and is received in the mobile device.

4. The mobile device of claim 2, wherein the output circuit has a switch button, allowing electric wire extending outside the mobile device to be coiled back to the receiving space of the mobile device by pushing the switch button.

5. The mobile device of claim 1, wherein the memory module consists of DRAM, SRAM or flash memory.

6. The mobile device of claim 1, wherein the controlling module adjusts the power within range of 3 V to 9 V.

7. The mobile device of claim 1, wherein the write in/read out unit of the input/output interface module has a data connecting port mounted therein.

8. The mobile device of claim 1, wherein the internal signal setting unit of the input/output interface module is provided with a switch.

9. The mobile device of claim 1, wherein the internal signal setting unit of the input/output interface module is provided with a keyboard.

10. The mobile device of claim 1, wherein the power source of the power supply module has an installing space for placing batteries therein.
